(19) United States
(12) Patent Application Publication
(10) Pub. No.: US 2024/0228866 A1
(43) Pub. Date: Jul. 11, 2024

(54) PROPPANT PARTICULATES FORMED FROM DELAYED COKE

(71) Applicant: ExxonMobil Technology and Engineering Company, Spring, TX (US)

(72) Inventors: Robert M. SHIRLEY, The Woodlands, TX (US); P. Matthew SPIECKER, Manvel, TX (US); Peter A. Gordon, Yardley, PA (US)

(21) Appl. No.: 18/558,780

(22) PCT Filed: Feb. 24, 2022
(86) PCT No.: PCT/US2022/070811

§ 371 Date: Nov. 3, 2023

Related U.S. Application Data
(60) Provisional application No. 63/186,987, filed on May 11, 2021.

(51) Int. Cl. C09K 8/80; C09K 8/66

(52) U.S. Cl. CPC C09K 8/80; C09K 8/66

(57) ABSTRACT

A fracturing fluid including proppant particulates formed from delayed coke, as well as a method for utilizing such fracturing fluid, are provided herein. The fracturing fluid includes a carrier fluid, as well as proppant particulates composed of delayed coke material. The method includes introducing the fracturing fluid into a subterranean formation and (optionally) depositing at least a portion of the proppant particulates within one or more fractures in the subterranean formation.

### CROSS-REFERENCE TO RELATED APPLICATION

This application is the U.S. National Stage Application of the International Application No. PCT/US2022/070811, entitled “PROPPANT PARTICULATES FORMED FROM DELAYED COKE,” filed on Feb. 24, 2022, the disclosure of which is hereby incorporated by reference in its entirety, which claims priority to and the benefit of U.S. Provisional Application No. 63/186,987 having a filing date of May 11, 2021, the disclosure of which is incorporated herein by reference in its entirety.

### FIELD OF THE INVENTION

The techniques described herein relate to fracturing operations and proppant particulates employed therein.

### BACKGROUND OF THE INVENTION

This section is intended to introduce various aspects of the art, which may be associated with embodiments of the present techniques. This discussion is believed to assist in providing a framework to facilitate a better understanding of particular aspects of the present techniques. Accordingly, it should be understood that this section should be read in this light, and not necessarily as admissions of prior art.

A wellbore is drilled into a subterranean formation to promote removal (or production) of a hydrocarbon or water resource therefrom. In many cases, the subterranean formation needs to be stimulated in some manner to promote removal of the resource. Stimulation operations include any operation performed upon the matrix of a subterranean formation to improve fluid conductivity therethrough, including hydraulic fracturing, which is a common stimulation operation for unconventional reservoirs.

Hydraulic fracturing operations involve the pumping of large quantities of fracturing fluid into a subterranean formation (e.g., a low-permeability formation) under high hydraulic pressure to promote the formation of one or more fractures within the matrix of the subterranean formation and to create high-conductivity flow paths. Primary fractures extending from the wellbore and, in some instances, secondary fractures extending from the primary fractures, possibly dendritically, are formed during a fracturing operation. These fractures may be vertical. horizontal, or a combination of directions forming a tortuous path.

Proppant particulates are often included within fracturing fluid. Once the fracturing fluid has been pumped into the subterranean formation, such proppant particulates ensure that the fractures within the matrix of the formation remain open after the hydraulic pressure has been released following the hydraulic fracturing operation. Specifically, upon reaching the fractures, the proppant particulates settle therein to form a proppant pack that prevents the fractures from closing once the hydraulic pressure has been released.

Difficulties are often encountered during hydraulic fracturing operations, such as, in particular, difficulties associated with the deposition of proppant particulates in fractures that have been created or extended under hydraulic pressure. Because proppant particulates are often dense materials compared to carrier fluids such as freshwater or brine, effective transport of the proppant particulates may be difficult due to settling, making it challenging to distribute the proppant particulates into more remote reaches of a network of fractures. In addition, fine-grained particles (referred to as “fines”) produced from crushing of proppant particulates within the fractures can also lessen fluid conductivity within the propped fractures, which may decrease production rates and necessitate wellbore cleanout and/or restimulation operations.

### SUMMARY OF THE INVENTION

An embodiment described herein provides a fracturing fluid including a carrier fluid and proppant particulates composed of delayed coke material. Another embodiment described herein provides a method including introducing a fracturing fluid into a subterranean formation, the fracturing fluid including a carrier fluid and proppant particulates composed of delayed coke material.

The proppant particulates may have one or more of: (1) an apparent density in the range of about 1.0 g/cm³ to about 2.0 g/cm³; (2) a carbon content of about 82 weight percent (wt %) to about 90 wt %; (3) a weight ratio of carbon to hydrogen of about 15:1 to about 30:1; (4) a sulfur content of about 2 wt % to about 8 wt %; (5) a nitrogen content of about 1 wt % to about 2 wt %; (6) a combined vanadium and nickel content of about 100 parts per million (ppm) to about 3,000 ppm; (7) a Krumbein roundness value of ≥0.6; (8) a Krumbein sphericity of ≥ 0.6; (9) an average particle size distribution in the range of about 70 microns (μm) to about 600 μm (depending on the grinding/milling technique used); and (10) a Hardgrove Grindability Index (HGI) value of about 40 to about 130.

These and other features and attributes of the disclosed embodiments of the present disclosure and their advantageous applications and/or uses will be apparent from the detailed description which follows.

### BRIEF DESCRIPTION OF THE DRAWINGS

To assist those of ordinary skill in the relevant art in making and using the subject matter thereof, reference is made to the appended drawings.

FIG. 1 is a graph showing settling rate as a function of particle size for several different mesh-sizes of sand and petroleum coke; and

FIG. 2 is a bar chart showing a comparison of compression test results for a Permian Basin regional sand sample, several fluid coke samples, and several delayed coke samples.

It should be noted that the figures are merely examples of the present techniques and are not intended to impose limitations on the scope of the present techniques. Further, the figures are generally not drawn to scale, but are drafted for purposes of convenience and clarity in illustrating various aspects of the techniques.

### DETAILED DESCRIPTION OF THE INVENTION

In the following detailed description section, the specific examples of the present techniques are described in connection with preferred embodiments. However, to the extent that the following description is specific to a particular embodiment or a particular use of the present techniques, this is intended to be for example purposes only and simply provides a description of the embodiments. Accordingly, the techniques are not limited to the specific embodiments described below, but rather, include all alternatives, modifications, and equivalents falling within the true spirit and scope of the appended claims.

### Definitions

At the outset, and for ease of reference, certain terms used in this application and their meanings as used in this context are set forth. To the extent a term used herein is not defined below, it should be given the broadest definition persons in the pertinent art have given that term as reflected in at least one printed publication or issued patent. Further, the present techniques are not limited by the usage of the terms shown below, as all equivalents, synonyms, new developments, and terms or techniques that serve the same or a similar purpose are considered to be within the scope of the present claims.

As used herein, the singular forms “a,” “an,” and “the” mean one or more when applied to any embodiment described herein. The use of “a,” “an,” and/or “the” does not limit the meaning to a single feature unless such a limit is specifically stated.

The terms “about” and “around” mean a relative amount of a material or characteristic that is sufficient to provide the intended effect. The exact degree of deviation allowable in some cases may depend on the specific context, c.g., ±1%, ±5%, ±10%, ±15%, etc. It should be understood by those of skill in the art that these terms are intended to allow a description of certain features described and claimed without restricting the scope of these features to the precise numerical ranges provided. Accordingly, these terms should be interpreted as indicating that insubstantial or inconsequential modifications or alterations of the subject matter described are considered to be within the scope of the disclosure.

The term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “including,” may refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein, the term “any” means one, some, or all of a specified entity or group of entities, indiscriminately of the quantity.

As used herein, the term “apparent density,” with reference to the density of proppant particulates, refers to the density of the individual particulates themselves, which may be expressed in grams per cubic centimeter (g/cm³). The apparent density values provided herein are based on the American Petroleum Institute's Recommended Practice 19C (hereinafter “API RP-19C”) standard, entitled “Measurement of Properties of Proppants Used in Hydraulic Fracturing and Gravel-packing Operations” (First Ed. May 2008, Reaffirmed June 2016).

The phrase “at least one,” in reference to a list of one or more entities, should be understood to mean at least one entity selected from any one or more of the entities in the list of entities, but not necessarily including at least one of each and every entity specifically listed within the list of entities, and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently, “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” may mean A alone, B alone, C alone, A and B together, A and C together, B and C together, A, B, and C together, and optionally any of the above in combination with at least one other entity.

As used herein, the phrase “based on” does not mean “based only on,” unless expressly specified otherwise. In other words, the phrase “based on” means “based only on,” “based at least on,” and/or “based at least in part on.

As used herein, the term “delayed coke” refers to the solid concentrated carbon material that is produced within delayed coking units via the delayed coking process. According to the delayed coking process, a preheated feedstock is introduced into a fractionator, where it undergoes a thermal cracking process in which long-chain hydrocarbons are split into shorter-chain hydrocarbons. The resulting lighter fractions are then removed as sidestream products. The fractionator bottoms, which include a recycle stream of heavy product, are heated in a furnace, which typically has an outlet temperature of around 895° F. to around 960° F. The heated feedstock then enters a reactor, referred to as a “coke drum,” which typically operates at temperatures of around 780° F. to around 840° F. Within the coke drum, the cracking reactions continue. The resulting cracked products then exit the coke drum as an overhead stream, while coke deposits on the inner surface of the coke drum. In general, this process is continued for a period of around 16 hours to around 24 hours to allow the coke drum to fill with coke. In addition, to allow the delayed coking unit to operate on a batch-continuous (or semi-continuous) basis, two or more coke drums are used. While one coke drum is on-line filling with coke, the other coke drum is being steam-stripped, cooled, decoked (e.g., via hydraulically cutting the deposited coke with water), pressure-checked, and warmed up. Moreover, the overhead stream exiting the coke drum enters the fractionator, where naphtha and heating oil fractions are recovered. The heavy recycle material is then typically combined with preheated fresh feedstock and recycled back into the process.

Furthermore, the term “delayed coke,” as used herein, encompasses several types of delayed coke with varying gross morphology characteristics, where such variations are primarily based on differences in operating variables and the nature of the feedstock. Such types of delayed coke may include, but are not limited to, sponge delayed coke, transition delayed coke, shot delayed coke, and/or needle delayed coke. More specifically, the term “sponge delayed coke” refers to a coherent. dull. porous delayed coke in which the individual spheres are not apparent. and the coke has a continuum of structure. The term “transition delayed coke” refers to a delayed coke having gross morphology characteristics that are between that of sponge delayed coke and shot delayed coke. The term “shot delayed coke” refers to a delayed coke that is generally considered undesirable for many applications due to its irregular structure. The term “needle delayed coke” (also referred to as “pitch delayed coke”) refers to a delayed coke that includes a highly crystalline structure and is, thus. generally considered desirable for many applications.

As used herein, the terms “example,” exemplary,” and “embodiment,” when used with reference to one or more components, features, structures, or methods according to the present techniques, are intended to convey that the described component, feature, structure, or method is an illustrative, non-exclusive example of components, features, structures, or methods according to the present techniques. Thus, the described component, feature, structure, or method is not intended to be limiting, required, or exclusive/exhaustive; and other components, features, structures, or methods, including structurally and/or functionally similar and/or equivalent components, features, structures, or methods, are also within the scope of the present techniques.

As used herein, the term “flexicoke” refers to the solid concentrated carbon material produced from FLEXICOKING™. The term “FLEXICOKING™” refers to a thermal cracking process utilizing fluidized solids and gasification for the conversion of heavy, low-grade hydrocarbon feeds into lighter hydrocarbon products (e.g., upgraded, more valuable hydrocarbons).

As used herein, the term “fluid coke” refers to the solid concentrated carbon material remaining from fluid coking. The term “fluid coking” refers to a thermal cracking process utilizing fluidized solids for the conversion of heavy, low-grade hydrocarbon feeds into lighter products (e.g., upgraded hydrocarbons), producing fluid coke as a byproduct.

As used herein, the term “fracture conductivity” refers to the ability of a fluid to flow through a fracture at various stress (or pressure) levels, which is based, at least in part, on the permeability and thickness of the fracture. The fracture conductivity values provided herein are based on the American Petroleum Institute's Recommended Practice 19D (API RP-19D) standard, entitled “Measuring the Long-Term Conductivity of Proppants” (First Ed. May 2008, Reaffirmed May 2015).

The term “petroleum coke” (or simply “coke”) refers to a final carbon-rich solid material that is derived from oil refining. More specifically, petroleum coke is the carbonization product of high-boiling hydrocarbon fractions that are obtained as a result of petroleum processing operations. Petroleum coke is produced within a coking unit via a thermal cracking process in which long-chain hydrocarbons are split into shorter-chain hydrocarbons. As described herein, there are three main types of petroleum coke: delayed coke, fluid coke, and flexicoke. Each type of petroleum coke is produced using a different coking process; however, all three coking processes have the common objective of maximizing the yield of distillate products within a refinery by rejecting large quantities of carbon in the residue as coke.

As used herein, the term “proppant particulate” refers to a solid material capable of maintaining open an induced fracture during and following a hydraulic fracturing treatment. The term “proppant pack” refers to a collection of proppant particulates.

The term “substantially,” when used in reference to a quantity or amount of a material, or a specific characteristic thereof, refers to an amount that is sufficient to provide an effect that the material or characteristic was intended to provide. The exact degree of deviation allowable may depend, in some cases, on the specific context.

Certain embodiments and features are described herein using a set of numerical upper limits and a set of numerical lower limits. It should be appreciated that ranges from any lower limit to any upper limit are contemplated unless otherwise indicated. All numerical values are “about” or “approximately” the indicated value, and account for experimental errors and variations that would be expected by a person having ordinary skill in the art.

Furthermore, concentrations, dimensions, amounts, and/or other numerical data that are presented in a range format are to be interpreted flexibly to include not only the numerical values explicitly recited as the limits of the range, but also all individual numerical values or sub-ranges encompassed within that range, as if each numerical value and sub-range were explicitly recited. For example, a disclosed numerical range of 1 to 200 should be interpreted to include, not only the explicitly-recited limits of 1 and 200, but also individual values, such as 2, 3, 4, 197, 198, 199, etc., as well as sub-ranges, such as 10 to 50, 20 to 100, etc.

As discussed above, proppant particulates can be effectively used during fracturing operations, but there are issues associated with their use. One issue is that the high densities of typical proppant particulates can hinder their transport within the carrier fluid, leading to inadequate proppant particulate deposition within the fractures and potentially resulting in a screen out condition, in which the deposited proppant particulates restrict fluid flow into the fractures such that continued injection of fracturing fluid would require injection pressures in excess of the safe limitations of the wellbore and/or associated wellhead equipment. Another issue is that some proppant particulates are prone to the formation of fines after the hydraulic pressure has been released following the hydraulic fracturing operation. Such fines may then migrate into the fractures and accumulate in sufficient quantity to reduce the fracture conductivity and, thus, negatively impact the wellbore productivity.

The present techniques alleviate the foregoing difficulties and provides related advantages as well. In particular, the present techniques provide proppant particulates formed from delayed coke, which exhibits desirably low densities and is also conveniently available in large quantities. Typically, delayed coke is used as a fuel source in various manufacturing processes for heat. However, delayed coke is a low-BTU fuel source. Therefore, by using delayed coke as a proppant rather than as a fuel source, CO₂ emissions may be reduced as a result of higher-BTU fuel sources replacing the delayed coke as a fuel source. In effect, using delayed coke as a proppant is a form of sequestering carbon that would otherwise contribute to CO₂ emissions.

Moreover, the costs associated with hydraulic fracturing may also be reduced, at least in part because large volumes of delayed coke are readily available from already-existent petroleum refinery process streams and are typically cost-competitive to sand. Furthermore, delayed coke is available in significantly larger quantities than fluid coke or flexicoke. In general, more than 90% of the coke produced in the United States is delayed coke. Therefore, the use of delayed coke as a proppant is advantageous due to the large quantities of proppant required for hydraulic fracturing operations. In particular, a hydraulic fracturing operation for a single hydrocarbon well typically requires somewhere within the range of around 10,000,000 pounds to around 30,000,000 pounds of proppant, depending on the wellbore length, operating conditions, and various other factors. Moreover, as described above, delayed coke is a low-BTU fuel source that significantly contributes to CO₂ emissions. Therefore, deposition of delayed coke as a proppant within the subterranean formations is an attractive, environmentally-friendly option as compared to the manner in which delayed coke is currently used.

Accordingly, embodiments described herein provide fracturing fluids including proppant particulates composed of delayed coke, derived from a delayed coking process. The delayed coke proppant particulates are suitable for propping one or more fractures induced during a hydraulic fracturing operation within a horizontal, vertical, or tortuous wellbore, including hydrocarbon-bearing production wellbores and water-bearing production wellbores.

### Properties of Proppant Particulates Formed from Delayed Coke

Hydraulic fracturing operations require effective proppant particulates to maintain the permeability and conductivity of a production well, such as for effective hydrocarbon recovery. Effective proppant particulates are typically associated with a variety of particular characteristics or properties, including efficient proppant particulate transport within a carrier fluid, sufficient strength to maintain propped fractures upon the removal of hydraulic pressure, and efficient conductivity once the wellbore is brought on production.

The rate of settling of a proppant particulate within a fracturing fluid at least in part determines its transport capacity within the fractures created during a hydraulic fracturing operation. The rate of settling of a proppant particulate can be determined using Equation 1:

$$v = \frac{{ρ}_{p} - {ρ}_{f}}{18 η} g {σ}^{2} , \qquad Equation 1$$

where v is the proppant particle; ρₚ−ρ_{f} is proportional to the density difference between the proppant particle and the carrier fluid; η is the viscosity of the carrier fluid; g is the gravitational constant; and σ² is proportional to the square of the proppant particulate size. As will be appreciated, proppant particulates having lower apparent densities and/or smaller average particle sizes settle at a slower rate within an identical carrier fluid (thus having better transport) compared to higher apparent density and/or larger average particle sized proppant particulates.

Proppant particulate efficacy is further related to fracture conductivity, characterized by the fluid flow rate in a propped fracture under gradient pressure, the fracture being propped by a proppant pack. Fracture conductivity, C_{f}, is the product of the proppant pack permeability, k, and its thickness, h, and may be determined using Equations 2 and 3:

C_{f}=kh Equation 2

$$k = \frac{1}{C} \frac{{ϕ}^{3}}{{( 1 - ϕ )}^{2}} {σ}_{eff}^{2} {Φ}_{s}^{2} , \qquad Equation 3$$

where C is a constant; ϕ is the proppant pack void fraction; o is the average particle size diameter of the proppant particulates; and Φ is a shape factor related to the asphericity of the proppant particulates. In tension with settling rate and transport, fracture conductivity favors proppant particulates having larger average particle size diameters, as well as thick proppant packs and narrow particle size distribution.

According to the present techniques, delayed coke was analyzed based on the aforementioned properties to determine its suitability for use as a proppant particulate. It was determined that delayed coke exhibits a number of characteristics (as described herein) that renders it, not only a viable alternative for traditional sand proppant particulates, but further a surprising substitute with enhanced functionality. Moreover, those skilled in the art will appreciate that the functionality of such delayed coke proppant particulates may be optimized when used in combination with traditional sand proppant particulates (and/or any other suitable type(s) of proppant particulates). For example, the delayed coke proppant particulates described herein may make up around one fourth to around one half (e.g., in some embodiments, around one third) by volume of the proppant particulates within a fracturing fluid, while traditional sand proppant particulates (and/or any other suitable type(s) of proppant particulates) may make up the remaining volume of the proppant particulates. Moreover, those skilled in the art will appreciate that, in some embodiments, the delayed coke proppant particulates may also be formed from some amount of fluid coke material and/or flexicoke material in addition to the delayed coke material, as described further herein. Turning now to details regarding the advantageous characteristics of delayed coke,

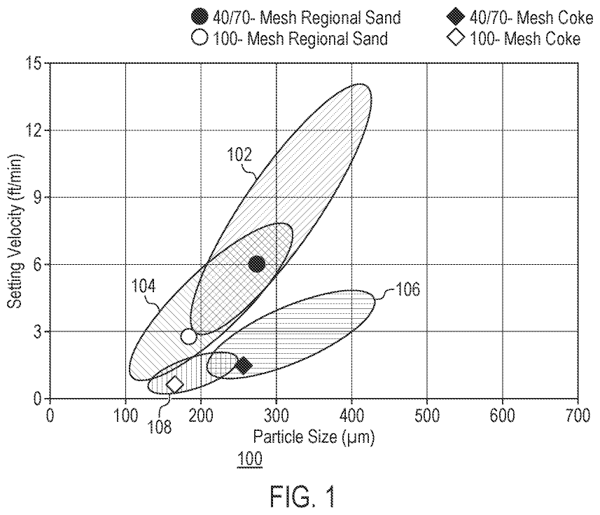

delayed coke has an apparent density range of around 1.0 g/cm³ to around 2.0 g/cm³, while sand generally has an apparent density of 2.5 g/cm³ or above. Therefore, because the settling rate is proportional to the difference in density between the solid particles and the carrier fluid (as shown in expressions for both Stokes terminal settling velocity and Ferguson & Church settling velocity), delayed coke has a significantly lower settling rate than sand. This concept is illustrated with respect to FIG. 1. Specifically, FIG. 1 is a graph 100 showing settling velocity as a function of particle size for several different mesh-sizes of sand and petroleum coke. Specifically, the graph 100 shows settling velocity (in feet per minute (ft/min)) as a function of particle size (in μm) for 40/70-mesh regional sand (as represented by a first region 102), 100-mesh regional sand (as represented by a second region 104), 40/70-mesh coke (as represented by a third region 106), and 100-mesh coke (as represented by a fourth region 108), where the settling velocity value is based on a modified Stokes settling velocity. As illustrated by the graph 100, coke has a significantly lower settling rate (or velocity) than sand for comparable particle sizes. As a result, proppant particulates formed from delayed coke material will perform better than proppant particulates formed from sand in terms of transport capacity within the fractures created during a hydraulic fracturing operation.

In various embodiments, the delayed coke proppant particulates described herein also exhibit the following properties: (1) a carbon content of about 82 wt % to about 90 wt %; (2) a weight ratio of carbon to hydrogen of about 15:1 to about 30:1; (3) a combined vanadium and nickel content of about 100 ppm to about 3,000 ppm; (4) a sulfur content of 2 wt % to about 8 wt %; and/or (5) a nitrogen content of 1 wt % to about 2 wt %, where such properties are measured on a dry, ash-free basis (or, in other words, not counting residual ash content and removing moisture before the analysis). In addition, the delayed coke proppant particulates described herein may have a moisture content of around 6 wt % to around 14 wt % and a volatile matter content of around 6 wt % to around 18 wt %, as measured on an as-received basis. Moreover, the apparent density of the delayed coke proppant particulates described herein may be in the range of about 1.0 grams per cubic centimeter (g/cm³) to about 2.0 g/cm³, although the exact apparent density of the particulates may vary depending on the type(s) of delayed coke utilized. In contrast, traditional sand proppant particulates generally have apparent densities greater than about 2.5 g/cm³. Thus, the delayed coke proppant particulates described herein have substantially lower apparent densities compared to traditional sand proppant particulates, which is indicative of their comparably more effective transport and lower settling rates within a fracture formed as part of a hydraulic fracturing operation.

Typical proppant particulates include sand having an average particle size distribution (i.e., diameter) in the range of about 100 microns (μm) to about 1000 μm. The delayed coke proppant particulates described herein may be comparable in particle size distribution, having an average particle size distribution in the range of, for example, about 70 microns (μm) to about 600 μm, depending on the grinding/milling technique used.

Furthermore, in various embodiments, the particle size distribution and other characteristics of the delayed coke proppant particulates described herein may vary depending on the specific type(s) of delayed coke utilized. In general, sponge delayed coke, transition delayed coke, needle delayed coke, shot delayed coke, and/or any other suitable types of delayed cokes may be used for the delayed coke proppant particulates described herein. However, in some embodiments, it may be particularly desirable to use shot coke (such as, for example, in the form of spherically-shaped granules having an initial particle size distribution of about 1 millimeter (mm) to about 5 mm prior to undergoing the grinding/milling process) for the delayed coke proppant particulates, either alone or in combination with other types of delayed coke. This may be due, at least in part, to the fact that shot coke is generally considered undesirable for many applications due to its irregular structure. Therefore, embodiments described herein enable large quantities of shot coke to be successfully utilized and then disposed of in an environmentally-friendly manner. In various embodiments, any suitable types of grinding/milling techniques may be used

to produce the delayed coke proppant particulates described herein from delayed coke granules received from a delayed coking process. For example, in some embodiments, the delayed coke granules may be processed using hammer milling techniques, jet milling techniques, ball milling techniques, or the like, where each of these techniques generally involves crushing or pulverizing the delayed coke granules to a suitable size and shape for use within the delayed coke proppant particulates described herein. Moreover, those skilled in the art will appreciate that any number of other grinding, milling, or other processing techniques may be additionally or alternatively used, depending on the details of the particular implementation.

As shown below, the deformation of the delayed coke proppant particulates described herein may be at least partially size dependent. In addition, in various embodiments, the delayed coke proppant particulates described herein have a Hardgrove Grindability Index (HGI) value of about 40 to about 130, where the HGI value is determined based on an API test related to strength.

The Krumbein Chart provides an analytical tool to standardize visual assessment of the sphericity and roundness of particles, including proppant particulates. Each of sphericity and roundness is visually assessed on a scale of 0 to 1, with higher values of sphericity corresponding to a more spherical particle and higher values of roundness corresponding to less angular contours on a particle's surface. According to API RP-19C standards, the shape of a proppant particulate is considered adequate for use in hydraulic fracturing operations if the Krumbein value for both sphericity and roundness is ≥0.6. In general, the delayed coke proppant particulates described herein exhibit a Krumbein value for both sphericity and roundness that is ≥ 0.6, and, thus, are suitable for use as proppant particulates. However, in practice, the Krumbein roundness and sphericity values for the delayed coke proppant particulates will vary based on the grinding/milling technique used to process the delayed coke material.

The long-term conductivity of a proppant pack including the delayed coke proppant particulates described herein is comparable to traditional sand proppant particulates, particularly at comparable particle sizes. Moreover, it is believed, without being bound by theory, that delayed coke proppant particulates may exhibit greater ductility compared to traditional sand proppant particulates, comparably decreasing their fines production under increasing stress.

The delayed coke proppant particulates described herein may be used as part of a fracturing fluid, including a flowable (e.g., liquid or gelled) carrier fluid and one or more optional additives. In various embodiments, this fluid is formulated at the well site in a mixing process that is conducted while it is being pumped in the hydraulic fracturing process. When the fluid is formulated at the well site, the delayed coke material can be added in a manner similar to the known methods for adding sand into the fracturing fluid. Furthermore, those skilled in the art will appreciate that green (or raw) delayed coke material received from a delayed coking process is typically first processed to remove any undesirable material that has adhered or otherwise conglomerated. Moreover, according to embodiments described herein, this processing step further includes grinding, milling, crushing, and/or pulverizing the green delayed coke material to obtain delayed coke material with a suitable particle size distribution to be used within the delayed coke proppant particulates described herein. In addition, in some embodiments, any fines that are not suitably sized for use within the delayed coke proppant particulates described herein are removed from the delayed coke material, such as, for example, using bag filters and/or screening equipment. As such, a more uniform size distribution may be obtained. Furthermore, it is within the scope of the present techniques that the delayed coke proppant particulates be included alone or in combination with one or more other types of proppant particulates, as described herein. When the delayed coke proppant particulates are included in combination with one or more other types of proppant particulates, the various particles can be mixed as a dry solid, mixed in a slurry, or added separately into a fracturing fluid that is being formulated at the well site.

The proppant particulates described herein, which are formed primarily from delayed coke material, may also be formed using some amount of fluid coke material and/or flexicoke material. In some embodiments, including more than one type of coke in this manner may allow the properties of the fracturing fluid to be further tailored to each particular application based on the differing physical characteristics of the different types of coke. In particular, delayed coke may have different physical and chemical characteristics than fluid coke and flexicoke due to the varying process conditions and feedstocks that are used to create each type of coke. For example. a comparison of scanning electron microscopic (SEM) images of a delayed coke sample, a flexicoke sample, and a fluid coke sample has revealed that delayed coke, unlike its counterparts, does not have large cracks on the surface or large amounts of internal porosity. In some cases, this may cause delayed coke to behave more favorably than fluid coke and flexicoke in terms of compressibility and strength. Moreover, those skilled in the art will appreciate that delayed coke has a wider range of possible characteristics than fluid coke and flexicoke because delayed coke is made from a batch process that varies based, at least in part, on the length of time the particles accumulate within the coke drum. Furthermore, delayed coke produced by one refinery may have significantly different characteristics from delayed coke produced by another refinery, where such differences may depend, at least in part, on the quality of feedstock used and the operating conditions for the coking unit. As a result, in some embodiments, delayed coke products from different refineries may be tested to identify a product with desirable characteristics for use as a proppant particulate.

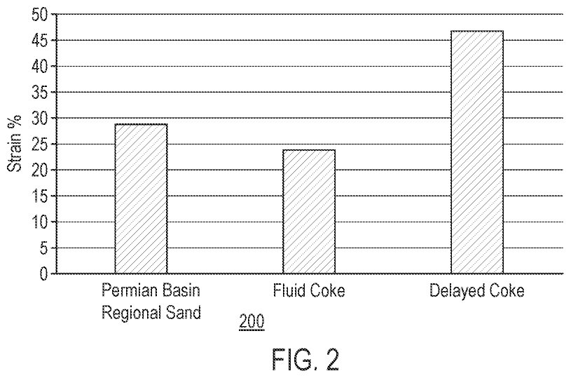

FIG. 2 is a bar chart 200 showing a comparison of compression test results (expressed as the percentage of strain at 5,000 psi and 180° F.) for a Permian Basin regional sand sample, several fluid coke samples, and several delayed coke samples. Specifically, the bar chart 200 shows compression test results for the Permian Basin regional sand sample, average compression tests result for two fluid coke samples, and average compression test results for three delayed coke samples. During each compression test, a fixed mass of the sample was compressed between two billets to a fixed level of stress. The sample was then slowly heated while the level of strain was measured. The test results revealed that none of the coke samples were temperature sensitive within the range tested. In addition, the test results revealed that the delayed coke samples had an average strain of 47% at 5,000 psi and 180° F., while the fluid coke samples had an average strain of 24% and the Permian Basin regional sand sample had a strain of 29% under the same conditions. Therefore, the hydraulic conductivity of fluid coke and sand may be slightly higher than that of the delayed coke, depending on the sizes and shapes of the particles used. However, the test results still indicate that delayed coke has a sufficient hydraulic conductivity to be successfully used as a proppant particulate.

The carrier fluid according to the present techniques may be an aqueous-based fluid or a nonaqueous-based fluid. Aqueous-based fluids may include, for example, fresh water, saltwater (including seawater), treated water (e.g., treated production water), other forms of aqueous fluid, or any combination thereof. One aqueous-based fluid class is often referred to as slickwater, and the corresponding fracturing operations are called slickwater fracturing. Nonaqueous-based fluids may include, for example, oil-based fluids (e.g., hydrocarbon, olefin, mineral oil), alcohol-based fluids (e.g., methanol), or any combination thereof.

In various embodiments, the viscosity of the carrier fluid may be altered by foaming or gelling. Foaming may be achieved using, for example, air or other gases (e.g., CO₂, N₂), alone or in combination. Gelling may be achieved using, for example, guar gum (e.g., hydroxypropyl guar), cellulose, or other gelling agents, which may or may not be crosslinked using one or more crosslinkers, such as polyvalent metal ions or borate anions, among other suitable crosslinkers.

In some instances, the carrier fluid used in hydraulic fracturing of horizontal wells is one or more of an aqueous-based fluid type, particularly in light of the large volumes of fluid typically required for hydraulic fracturing (e.g., about 60,000 to about 1,000,000 gallons per wellbore). The aqueous-based fluid may or may not be gelled. Gelled, either crosslinked or uncrosslinked, fluids may facilitate better proppant particulate transport (reduced settling), as well as improved physical and chemical strength to withstand the temperature, pressure, and shear stresses encountered by the fracturing fluid during a hydraulic fracturing operation. In some instances, the fracturing fluid may include an aqueous-based carrier fluid, which may or may not be foamed or gelled, and an acid (e.g., HCl) to further stimulate and enlarge pore areas of the matrix of fracture surfaces. It is to be appreciated that the low density of the delayed coke proppant particulates described herein may allow a reduction or elimination of the need to foam or gel the carrier fluid. In addition, certain fracturing fluids suitable for use according to embodiments described herein may contain one or more additives such as, for example, dilute aids, biocides, breakers, corrosion inhibitors, crosslinkers, friction reducers (e.g., polyacrylamides), gels, salts (e.g., KCl), oxygen scavengers, pH control additives, scale inhibitors, surfactants, weighting agents, inert solids, fluid loss control agents, emulsifiers, emulsion thinners, emulsion thickeners, viscosifying agents, particulates, lost circulation materials, foaming agents, gases, buffers, stabilizers, chelating agents, mutual solvents, oxidizers, reducers, clay stabilizing agents, or any combination thereof.

### Hydraulic Fracturing Methods Utilizing Proppant Particulates Formed from Delayed Coke

The present techniques provide methods of hydraulic fracturing using a fracturing fluid including proppant particulates formed from delayed coke (optionally in combination with one or more other types of coke material, such as fluid coke and/or flexicoke). Such delayed coke proppant particulates may be used, alone or in combination with other proppant particulates, during a hydraulic fracturing operation. That is, the delayed coke proppant particulates may form the entirety of a proppant pack or may form an integral part of a proppant pack. Other proppant particulate types that may be utilized with the delayed coke proppant particulates described herein include, but are not limited to, the traditional sand proppant particulates described herein, as well as those made from bauxite, ceramic, glass, or any combination thereof, and may or may not have surface modifications. Proppant particulates composed of other materials are also within the scope of the present techniques, provided that any such selected proppant particulates (including those composed of the aforementioned materials) are able to maintain their integrity upon removal of hydraulic pressure within an induced fracture, such that about 80%, preferably about 90%, and more preferably about 95% or greater of the particle mass of the other proppant particulates retains integrity when subjected to 5000 psi of stress, a requirement also met by the delayed coke proppant particulates described herein. That is, both the delayed coke proppant particulates and any other proppant particulates used in the methods described herein must maintain mechanical integrity upon fracture closure, as both types of particulates must intermingle or otherwise associate to form functional proppant packs for a successful hydraulic fracturing operation.

The methods described herein include preparation of fracturing fluid, which is not considered to be particularly limited, because the delayed coke proppant particulates are capable of transportation in dry form or as part of a wet slurry from a manufacturing site (e.g., a refinery or synthetic fuel plant). Dry and wet forms may be transported via truck or rail, and wet forms may further be transported via pipelines. The transported dry or wet form of the delayed coke proppant particulates may be added to a carrier fluid, including optional additives, at a production site, either directly into a wellbore or by pre-mixing in a hopper or other mixing equipment. In some embodiments, for example, when the entirety of the proppant particulates within the fracturing fluid at a given time are delayed coke proppant particulates, slugs of the dry or wet form may be added directly to the fracturing fluid (e.g., as it is introduced into the wellbore). These slugs of only delayed coke proppant particulates may be followed by subsequent slugs of, again, only delayed coke proppant particulates or of a mixture of delayed coke proppant particulates and other proppant particulates. In other embodiments, such as when other proppant particulate types are combined with the delayed coke proppant particulates, a portion or all of the fracturing fluid may be pre-mixed at the production site or each proppant type may be added directly to the fracturing fluid separately. Any other suitable mixing or adding of the delayed coke proppant particulates to produce a desired fracturing fluid composition may also be used, without departing from the scope of the present techniques.

The methods of hydraulic fracturing suitable for use in one or more embodiments described herein involve pumping fracturing fluid including delayed coke proppant particulates at a high pump rate into a subterranean formation to form at least a primary fracture, as well as potentially one or more secondary fractures extending from the primary fracture, one or more tertiary fractures extending from the secondary fractures, and the like (all collectively referred to as a “fracture”). In a preferred embodiment, this process is conducted one stage at a time along a horizontal well. The stage is hydraulically isolated from any other stages which have been previously fractured. In one embodiment, the stage being fractured has clusters of perf holes (c.g., perforations in the wellbore and/or subterranean formation) allowing flow of hydraulic fracturing fluid through a metal tubular casing of the horizontal well into the formation. Such metal tubular casings are installed as part of the completions when the well is drilled and serve to provide mechanical integrity for the horizontal wellbore. In some embodiments, the pump rate for use during hydraulic fracturing may be at least about 20 barrels per minute (bbl/min), preferably about 30 bbl/min, and more preferably in excess of 50 bbl/min and less than 1000 bbl/min at one or more time durations during the fracturing operation (e.g., the rate may be constant, steadily increased, or pulsed). These high rates may, in some embodiments, be utilized after about 10% of the entire volume of fracturing fluid to be pumped into the formation has been injected. That is, at the carly periods of a hydraulic fracturing operation, the pump rate may be lower and as fractures begin to form, the pump rate may be increased. Generally, the average pump rate of the fracturing fluid throughout the operation may be about 10 bbl/min, preferably about 15 bbl/min, and more preferably in excess of 25 bbl/minute and less than 250 bbl/min. Typically, the pump rate during a fracturing operation for more than 30% of the time required to complete fracturing of a stage is in the range of about 20 bbl/min to about 150 bbl/min, or about 40 bbl/min to about 120 bbl/min, or about 40 bbl/min to about 100 bbl/min.

In various embodiments, the methods of hydraulic fracturing described herein may be performed such that the concentration of the proppant particulates (including delayed coke proppant particulates and any other proppant particulates) within the injected fracturing fluid is altered (i.e., on-the-fly while the fracturing operation is being performed, such that hydraulic pressure is maintained within the formation and fracture(s)). For example, in some embodiments, the initially-injected fracturing fluid may be injected at a low pump rate and may include 0 volume % (vol %) to about 1 vol % proppant particulates. As one or more fractures begin to form and grow, the pump rate may be increased and the concentration of proppant particulates may be increased in a stepwise fashion (with or without a stepwise increase in pump rate), with a maximum concentration of proppant particulates reaching about 2.5 vol % to about 20 vol %, encompassing any value and subset therebetween. For example, the maximum concentration of proppant particulates may reach at least 2.5 vol %, preferably about 8 vol %, and more preferably about 16 vol %. In some embodiments, all of the proppant particulates are delayed coke proppant particulates. In other embodiments, at one or more time periods during the hydraulic fracturing operation, at least about 2 vol % to about 100 vol % of any proppant particulates suspended within the fracturing fluid are delayed coke proppant particulates, such as at least about 2 vol %, preferably about 15 vol %, more preferably about 25 vol %, and even more preferably 100 vol %.

It should be noted that, in some embodiments, any or all of the delayed coke proppant particles may be coated. Coatings are often used on sand particles used in hydraulic fracturing to cither improve their flowability or to mitigate flowback during production. Such types of coatings are within the scope of the present techniques. It is possible to introduce coated delayed coke proppant particles at any stage of the hydraulic fracturing process, with the resulting delayed coke composition being either a mixture of coated and uncoated delayed coke or entirely coated delayed coke.

In various embodiments, the delayed coke proppant particulates are introduced into the subterranean formation after about 1/8 to about 3/4 of the total volume of fracturing fluid has been injected into the formation. Because of the low density of the delayed coke proppant particulates described herein, it may be beneficial in some cases to introduce the delayed coke proppant particulates during later time periods of fracturing after which the fractures have already grown substantially, such that the delayed coke proppant particulates can travel within the fracturing fluid to remote locations of the formed fractures. Accordingly, the delayed coke proppant particulates described herein provide significant advantages over currently-available, denser proppant particulates, which are typically not able to effectively reach such remote locations due to settling effects, for example.

Additionally or alternatively, in various embodiments, the delayed coke proppant particulates are introduced into the subterranean formation during the early phases of the fracturing operation to allow the proppant particulates to travel with the fracturing fluid into the tips (or at least within proximity to the tips) of the formed fractures. In such embodiments, the delayed coke proppant particulates may also be introduced into the formation during the later phases of the fracturing operation such that the later-introduced slurry of fracturing fluid and proppant particulates continue to displace the earlier-introduced slurry of fracturing fluid and proppant particulates further away from the wellbore. Moreover, in some embodiments, the delayed coke proppant particulates are introduced into the formation throughout the fracturing operation, either continuously or intermittently. In such embodiments, the ratio of delayed proppant particulates and conventional proppant (e.g., sand) introduced into the formation may optionally be maintained at a steady (or substantially steady) value.

The hydraulic fracturing methods described herein may be performed in drilled horizontal, vertical, or tortuous wellbores, including hydrocarbon-producing (c.g., oil and/or gas) wellbores and/or water-producing wellbores. Such wellbores may be drilled into various types of formations, including, but not limited to, shale formations, oil sand formations, gas sand formations, and the like.

The wellbores are typically completed using a metal (c.g., steel) tubular or casing that is cemented into the subterranean formation. To contact the formation, a number of perforations are created through the tubular and cement along a section to be treated, usually referred to as a plug and perforated (“plug and perf”) cased-hole completion. Alternative completion techniques may be used without departing from the scope of the present techniques, but in each completion technique, a finite length of the wellbore is exposed for hydraulic fracturing and injection of fracturing fluid. This finite section is referred to herein as a “stage.” In plug and perf completions, the stage length may be based on a distance over which the tubular and cement has been perforated, and may be in the range of about 10 feet (ft) to about 2000 ft, for example, and more generally in the range of about 100 ft to about 300 ft. The stage is isolated (e.g., using a sliding sleeve or frac plug and ball) such that pressurized fracturing fluid from the surface can flow through the perforations and into the formation to generate one or more fractures in only the stage area. Clusters of perforations may be used to facilitate initiation of multiple fractures. For example, clusters of perforations may be made in sections of the stage that are about 1 ft to about 3 ft in length, and spaced apart by about 10 ft to about 50 ft.

For each linear foot of the stage, at least about 6 barrels (about 24 cubic feet (ft³)), preferably about 24 barrels (about 135 ft³), and more preferably at least 60 barrels (about 335 ft3) and less than 6000 barrels (about 33,500 ft³) of fracturing fluid may be injected to grow the fractures. In certain embodiments, for each linear foot of the stage, at least about 1.6 ft³, preferably about 6.4 ft³, and more preferably at least 16 ft³ and less than 1600 ft³ of proppant particulates may be injected to prop the fractures. In some embodiments, to prevent bridging of the proppant particulates during injection into the fractures, the ratio of the volume of the proppant particulates to the liquid portion of the fracturing fluid, primarily the carrier fluid, is greater than 0 and less than about 0.25 and preferably less than about 0.15. If the volume ratio becomes too large, a phenomenon known as “screening out” will occur.

Certain commercial operations, such as commercial shale fracturing operations, may be particularly suitable for hydraulic fracturing using the delayed coke proppant particulates and methods described herein, as the mass of proppant particulates required per stage in such operations can be quite large and substantial economic benefit may be derived by using the delayed coke proppant particulates. The cost of delayed coke particles can be less than the cost of sand, which provides a significant economic benefit. Indeed, in some instances, a stage in a shale formation may be designed to require at least about 30,000, preferably about 100,000, and more preferably about 250,000 pounds (mass) of proppant particulates. In such cases, economic and performance benefit may be optimized when at least about 5%, preferably more than about 25%, and up to 100% of the proppant particulate mass includes delayed coke proppant particulates.

Furthermore, in general, multiple stages of the wellbore are isolated, and hydraulic fracturing is performed for each stage. The delayed coke proppant particulates described herein may be used in any number of the stages, including, for example, at least 2 stages, preferably at least 10 stages, and more preferably at least 20 stages.

### Exemplary Embodiments of Present Techniques

In one or more embodiments, the present techniques may be susceptible to various modifications and alternative forms, such as the following embodiments as noted in paragraphs 1 to 20:

1. A fracturing fluid, comprising: carrier fluid; and proppant particulates composed of delayed coke material.

2. The fracturing fluid of paragraph 1, further comprising second proppant particulates composed of a material that is not the delayed coke material.

3. The fracturing fluid of paragraph 1 or 2, wherein the delayed coke material is provided by processing delayed coke granules using at least one grinding or milling technique.

4. The fracturing fluid of any of paragraphs 1 to 3, wherein the proppant particulates have an apparent density in the range of 1.0 grams per cubic centimeter (g/cm³) to 2.0 g/cm³.

5. The fracturing fluid of any of paragraphs 1 to 4, wherein the delayed coke proppant particulates have one or more of: (a) a carbon content of 82 weight percent (wt %) to 90 wt %; (b) a weight ratio of carbon to hydrogen of 15:1 to 30:1; (c) a sulfur content of 2 wt % to 8 wt %; (d) a nitrogen content of 1 wt % to 2 wt %; and (e) a combined vanadium and nickel content of 100 parts per million (ppm) to 3,000 ppm.

6. The fracturing fluid of any of paragraphs 1 to 5, wherein the proppant particulates have a Hardgrove Grindability Index (HGI) value of 40 to 130.

7. The fracturing fluid of any of paragraphs 1 to 6, wherein the proppant particulates have a Krumbein roundness value and a Krumbein sphericity value of ≥0.6, and wherein the Krumbein roundness value and the Krumbein sphericity value vary based on a grinding or milling technique used to process the delayed coke material.

8. The fracturing fluid of any of paragraphs 1 to 7, wherein the proppant particulates have an average particle size distribution in the range of 70 microns (μm) to 600 μm, depending on a grinding or milling technique used to process the delayed coke material.

9. The fracturing fluid of any of paragraphs 1 to 8, wherein the proppant particulates are further composed of a fluid coke material or a flexicoke material, or some combination thereof, in addition to the delayed coke material.

10. A method, comprising introducing a fracturing fluid into a subterranean formation, the fracturing fluid comprising a carrier fluid and proppant particulates composed of delayed coke material.

11. The method of paragraph 10, further comprising depositing at least a portion of the proppant particulates within one or more fractures in the subterranean formation.

12. The method of paragraph 10 or 11, wherein the fracturing fluid further comprises second proppant particulates composed of a material that is not the delayed coke material.

13. The method of any of paragraphs 10 to 12, comprising providing the delayed coke material by processing delayed coke granules using at least one grinding or milling technique.

14. The method of any of paragraphs 10 to 13, wherein the proppant particulates are further composed of a fluid coke material or a flexicoke material, or some combination thereof, in addition to the delayed coke material.

15. The method of any of paragraphs 10 to 14, further comprising sequestering carbon in the subterranean formation in the form of the delayed coke material.

16. The method of any of paragraphs 10 to 15, wherein the proppant particulates have an apparent density in the range of 1.0 grams per cubic centimeter (g/cm³) to 2.0 g/cm³.

17. The method of any of paragraphs 10 to 16, wherein the delayed coke proppant particulates have one or more of: (a) a carbon content of 82 wt % to 90 weight percent (wt %); (b) a weight ratio of carbon to hydrogen of 15:1 to 30:1; (c) a sulfur content of 2 wt % to 8 wt %; (d) a nitrogen content of 1 wt % to 2 wt %; and (e) a combined vanadium and nickel content of 100 parts per million (ppm) to 3,000 ppm.

18. The method of any of paragraphs 10 to 17, wherein the proppant particulates have an HGI value of 40 to 130.

19. The method of any of paragraphs 10 to 18, wherein the proppant particulates have a Krumbein roundness value and a Krumbein sphericity value of ≥0.6, and wherein the Krumbein roundness value and the Krumbein sphericity value vary based on a grinding or milling technique used to process the delayed coke material.

20. The method of any of paragraphs 10 to 19, wherein the carrier fluid is an aqueous carrier fluid.

While the embodiments described herein are well-calculated to achieve the advantages set forth, it will be appreciated that such embodiments are susceptible to modification, variation, and change without departing from the spirit thereof. In other words, the particular embodiments described herein are illustrative only, as the teachings of the present techniques may be modified and practiced in different but equivalent manners apparent to those skilled in the art having the benefit of the teachings herein. Furthermore, no limitations are intended on the details of formulation, construction, or design herein shown, other than as described in the claims below. Moreover, the systems and methods illustratively disclosed herein may suitably be practiced in the absence of any element that is not specifically disclosed herein and/or any optional element disclosed herein. While compositions and methods are described in terms of “comprising” or “including” various components or steps, the compositions and methods can also “consist essentially of” or “consist of” the various components and steps. Indeed, the present techniques include all alternatives, modifications, and equivalents falling within the true spirit and scope of the appended claims.

What is claimed is:

1. A fracturing fluid, comprising:
carrier fluid; and
proppant particulates composed of delayed coke material.

2. The fracturing fluid of claim 1, further comprising second proppant particulates composed of a material that is not the delayed coke material.

3. The fracturing fluid of claim 1, wherein the delayed coke material is provided by processing delayed coke granules using at least one grinding or milling technique.

4. The fracturing fluid of claim 1, wherein the proppant particulates have an apparent density in the range of 1.0 grams per cubic centimeter (g/cm³) to 2.0 g/cm³.

5. The fracturing fluid of claim 1, wherein the delayed coke proppant particulates have one or more of: (a) a carbon content of 82 weight percent (wt %) to 90 w1%; (b) a weight ratio of carbon to hydrogen of 15:1 to 30:1; (c) a sulfur content of 2 wt % to 8 wt %; (d) a nitrogen content of 1 wt % to 2 wt %; and (c) a combined vanadium and nickel content of 100 parts per million (ppm) to 3,000 ppm.

6. The fracturing fluid of claim 1, wherein the proppant particulates have a Hardgrove Grindability Index (HGI) value of 40 to 130.

7. The fracturing fluid of claim 1, wherein the proppant particulates have a Krumbein roundness value and a Krumbein sphericity value of ≥0.6, and wherein the Krumbein roundness value and the Krumbein sphericity value vary based on a grinding or milling technique used to process the delayed coke material.

8. The fracturing fluid of claim 1, wherein the proppant particulates have an average particle size distribution in the range of 70 microns (μm) to 600 μm, depending on a grinding or milling technique used to process the delayed coke material.

9. The fracturing fluid of claim 1, wherein the proppant particulates are further composed of a fluid coke material or a flexicoke material, or some combination thereof, in addition to the delayed coke material.

10. A method, comprising introducing a fracturing fluid into a subterranean formation, the fracturing fluid comprising a carrier fluid and proppant particulates composed of delayed coke material.

11. The method of claim 10, further comprising depositing at least a portion of the proppant particulates within one or more fractures in the subterranean formation.

12. The method of claim 10, wherein the fracturing fluid further comprises second proppant particulates composed of a material that is not the delayed coke material.

13. The method of claim 10, comprising providing the delayed coke material by processing delayed coke granules using at least one grinding or milling technique.

14. The method of claim 10, wherein the proppant particulates are further composed of a fluid coke material or a flexicoke material, or some combination thereof, in addition to the delayed coke material.

15. The method of claim 10, further comprising sequestering carbon in the subterranean formation in the form of the delayed coke material.

16. The method of claim 10, wherein the proppant particulates have an apparent density in the range of 1.0 grams per cubic centimeter (g/cm³) to 2.0 g/cm³.

17. The method of claim 10, wherein the delayed coke proppant particulates have one or more of: (a) a carbon content of 82 wt % to 90 weight percent (wt %); (b) a weight ratio of carbon to hydrogen of 15:1 to 30:1; (c) a sulfur content of 2 wt % to 8 wt %; (d) a nitrogen content of 1 wt % to 2 wt %; and (e) a combined vanadium and nickel content of 100 parts per million (ppm) to 3,000 ppm.

18. The method of claim 10, wherein the proppant particulates have a Hardgrove Grindability Index (HGI) value of 40 to 130.

19. The method of claim 10, wherein the proppant particulates have a Krumbein roundness value and a Krumbein sphericity value of ≥0.6, and wherein the Krumbein roundness value and the Krumbein sphericity value vary based on a grinding or milling technique used to process the delayed coke material.

20. The method of claim 10, wherein the carrier fluid is an aqueous carrier fluid.
